(19) United States
(12) Patent Application Publication
(10) Pub. No.: US 2013/0160706 A1
(43) Pub. Date: Jun. 27, 2013

(54) DEVICE FOR COATING A WAFER

(71) Applicants: Johanna Bartel, Hofkirchen (DE); Ronald Holzleitner, Scharnstein (AT); Raimund Hoffmann, Soding (AT); Franz Schrank, Graz (AT); Jordi Teva-Meroño, Graz (AT)

(72) Inventors: Johanna Bartel, Hofkirchen (DE); Ronald Holzleitner, Scharnstein (AT); Raimund Hoffmann, Soding (AT); Franz Schrank, Graz (AT); Jordi Teva-Meroño, Graz (AT)

(21) Appl. No.: 13/820,331

(22) PCT Filed: Oct. 19, 2010
(86) PCT No.: PCT/EP10/06372

§ 371 Date: Mar. 1, 2013

(51) Int. Cl. B05B 13/02

(52) U.S. Cl. CPC B05B 13/0228
USPC 118/320

(57) ABSTRACT

The invention relates to a device for coating a surface of a wafer. The device includes a retaining system for placing the wafer on a retaining surface, a nozzle system for coating the wafer in a Z-direction, and a ring having an inside periphery that surrounds a side periphery of the wafer (2), wherein the ring can be arranged for expanding a coating surface when coating the wafer.

The invention relates to a device for coating a surface of a wafer according to Claim 1.

When coating wafers in spray-enameling plants, the problem exists of evenly applying the coating, in particular paint, on the by now very large-surface wafer, for example with a diameter of 300 mm. The uniform coating in the edge area of the wafer has proven to be especially problematic.

The object of the invention is therefore to indicate a device for coating wafers in which the coating, in particular in the edge area of the wafer, is more even.

This object is achieved with the features of Claim 1. Advantageous further developments of the invention are indicated in the subclaims. All combinations of at least two of the features indicated in the description, the claims and/or the figures also fall within the scope of the invention. In the case of indicated value ranges, values that are within the above-mentioned limits are also to be disclosed as boundary values and can be claimed in any combination.

The invention is based on the idea that by providing an additional component in the device according to the invention, the coating surface of the wafer can be quasi-expanded, by which in the edge area of the wafer, it has turned out, surprisingly enough, that the evenness of the coating applied by the device according to the invention is improved in particular in the edge area. From the standpoint of the nozzle system for coating the wafer, the edge area of the wafer is moved almost to the ring, so that the actual edge of the wafer and thus the entire wafer is evenly coated.

According to one embodiment, the ring surrounding the wafer on a side periphery of the wafer with its inside periphery for expanding the coating surface formed from the surface of the wafer and a face of the wafer can advantageously be replaced according to one embodiment and thus can be matched to the outside contour or the shape and size of the wafer. In the case of a circular wafer, the ring is accordingly circular, at least on its inside contour, i.e., on the inside periphery.

According to an advantageous embodiment of the invention, it is provided that the ring, in particular L-shaped in cross-section, can be arranged concentrically to the wafer, in particular at a gap H between the inside periphery and the side periphery between 100 μm and 2,000 μm, preferably between 100 μm and 500 μm. The minimum gap H of the wafer, relative to the wafer diameter, between the edge of the wafer and the ring keeps the wafer from bonding to the ring; in addition, at the same time, a rotation of the wafer during coating is made possible. By the concentric arrangement of the wafer to the ring or the ring to the wafer, a uniform gap H between the wafer and the ring, which in turn leads to a more even result of the coating in the edge area of the wafer, is produced. Coating material, which penetrates between the ring and the wafer, is collected by the L-shaped configuration of the ring, so that by the configuration according to the invention, a cleaning of the device is considerably facilitated by excess coating material adhering primarily on the ring, so that only the ring has to be cleaned or replaced, and the other components of the device have to be cleaned only comparatively rarely.

If an upper ring surface of the ring can be arranged above the retaining surface, in particular aligned with or above the surface, the evenness of the coating result is further enhanced, since the coating material is distributed uniformly on the surface or the coating surface after the exit from the nozzle system, in particular in the edge area of the wafer.

In addition, it is advantageously provided that the ring can be adjusted by an X-Y adjustment system in an X-Y plane relative to the wafer that runs parallel to the retaining surface. By this measure according to the invention, it is made possible to concentrically orient the ring relative to the wafer that is fixed in particular on the retaining system.

As an alternative, the ring is fixed in the device in an X-Y direction, which runs orthogonally to the Z direction; i.e., it thus has only one degree of freedom in the Z direction. In this embodiment, the concentric orientation of the wafer to the ring is implemented when the wafer is retained on the retaining surface by the wafer being applied concentrically to the ring or the gap between the wafer and the ring being adjusted as uniformly as possible. The orientation of the wafer to the ring can be done by optical detection means or in other ways known in the prior art.

According to another advantageous embodiment of the invention, it is provided that the ring can be adjusted relative to the wafer by a Z-adjustment system in the Z-direction directed orthogonally to the retaining surface and sliding-guided in particular in the X-Y adjustment system in the Z-direction. By this measure according to the invention, the upper ring surface of the ring can be adjusted in height relative to the surface of the wafer in the Z-direction, so that an optimal coating of the surface is made possible.

By the ring being able to be arranged without contact on the wafer, preferably essentially equidistant in the Z-direction and/or orthogonal to the peripheral direction of the wafer, the evenness of the coating of the surface of the wafer is further enhanced.

In another advantageous embodiment of the invention, it is provided that the ring can be arranged in such a way that the coating surface is formed from the surface and the upper ring surface of the ring, directed in the Z-direction.

Other advantages, features, and details of the invention will emerge from the subsequent description of preferred embodiments as well as based on the drawings. Here:

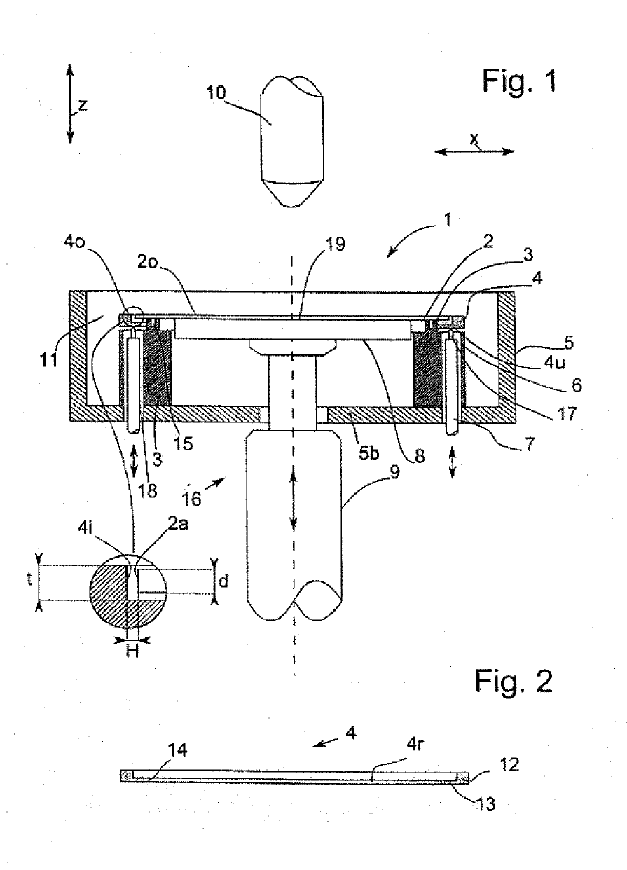

FIG. 1 shows a diagrammatic, cutaway side view of the device according to the invention, and

FIG. 2 shows a diagrammatic view of a ring according to the invention.

In FIG. 1, the coating device 1 according to the invention is shown in an embodiment, whereby a cutaway on the left edge of a wafer 2, which is of decisive importance for this invention, is shown enlarged.

The wafer 2 is laid down with a robotic arm, not shown, on a chuck 8 of a retaining system 16 that can be rotated and adjusted in height in a Z-direction and is oriented centered relative to a circular ring 4 during or after being laid down and placed on the retaining system. The rotation of the retaining system 16 is carried out by a shaft 9 with a shaft drive, not shown.

The wafer 2 is laid down on the chuck 8 in such a way that its surface 2o has the side facing away from the chuck 8 pointing toward a nozzle system 10 in the Z-direction.

The nozzle system 10 can be moved along the surface 2o in an X-Y plane that runs crosswise to the Z-direction to coat the entire surface 2o evenly with a coating substance. The coating substance is, for example, photoresist.

A coating space 11, in which the coating of the wafer 2 takes place, is formed by a housing wall 5 of the coating device 1. The shaft 9 passes through the center of a bottom 5b of the housing wall 5, and the retaining system 16 can be moved in the Z-direction.

On the side periphery 2a of the wafer 2, the ring 4 can be arranged in such a way that an inside periphery 4i of the L-shaped ring 4 in cross-section is arranged in such a way that the inside periphery 4i faces the side periphery 2a of the wafer 2. The ring 4 completely surrounds the wafer 2 on its side periphery 2a, namely with its outer leg 12. An inner leg 13 of the ring that points from the outer leg 12 in the direction of the retaining system 16 in the X-direction and the Y-direction extends over the side periphery 2a in the direction of the center of the wafer and forms a ring opening 4r, through which, i.a., the chuck 8 runs.

The ring opening 4r is formed by an inside ring surface 14 of the ring 4 (see FIG. 2).

The ring 4 is fixed in the X- and Y-directions, i.e., in an X-Y plane by an X-Y fixing 6, by a fixing ring 3 projecting upward from the X-Y fixing 6 being fixed by attachment of the fixing ring 3 to the inside ring surface 14 in the X-Y-direction.

The fixing ring 3 and/or the X-Y fixing 6 can be distributed on the periphery of the ring 4 at at least three points, i.e., not designed to have a closed periphery. The fact that the X-Y fixing 6 to the ring 4 occupies two degrees of freedom in the X- and Y-directions, i.e., in the X-Y plane, is decisive.

In addition, a vacuum system 15, which is used for fixing the wafer 2 to the X-Y fixing 6, is provided in the fixing ring 3.

For height adjustment of the ring 4, a Z-adjustment system 7 is provided in the form of several pins 17 arranged on the periphery of the ring 4 and movable in the Z-direction, pins which rest on the lower side 4u of the ring 4 facing away from the upper ring surface 4o. The pins 17 can be moved synchronously in the Z-direction by the Z-adjustment system 7 to keep the ring 4 from tilting on the fixing ring 3.

The pins 17 run into the guide openings 18 of the X-Y fixing 6, so that the X-Y fixing 6 simultaneously also fixes the pins 17 in the X- and Y-directions.

The diameter of the ring 4 on the inside periphery 4i is larger than the diameter of the wafer 2 on the side periphery 2a, so that a gap H can be adjusted between the inside periphery 4i and the side periphery 2a.

By a thickness d of the wafer 2 being measurable or known by the coating device 1 and at the same time a height t of the inside periphery 4i being specified, the upper ring surface 4o can be oriented to the surface 2o in such a way that the upper ring surface 4o rises above the surface 20 or is aligned with the latter in the X-Y plane.

The sequence of the coating with the coating device 1 according to the embodiment of FIG. 1 is as follows:
Inserting a ring 4 with an inside periphery 4i matched to the wafer 2 to be coated,
Placing the wafer 2 on the chuck 8,
Aligning the wafer 2 concentrically to the ring 4, so that an equidistant gap H between the wafer 2 and the ring 4, in particular the side periphery 2a and the inside periphery 4i, prevails,
Optionally lowering the retaining system 16, so that the wafer 2 comes to rest on the fixing ring 3,
Optionally including fixing the wafer 2, in particular by suctioning off by the vacuum system 15,
Aligning the ring 4 in the Z-direction, so that the upper ring surface 4o is aligned with the surface 2o or rises above the latter,
Coating the surface 2o with the nozzle system 10 with coating material by systematic separating of the surface 2o,
Releasing the vacuum of the vacuum system 15, and
Lifting the wafer 2 in the Z-direction by the retaining system 16 and lowering the wafer 2 from the chuck 8 by a robotic arm, not shown.

### LIST OF REFERENCE SYMBOLS

1 Coating device
2 Wafer
2o Surface
2a Side periphery
3 Fixing ring
4 Ring
4i Inside periphery
4o Upper ring surface
4r Ring opening
5 Housing wall
5b Bottom
6 X-Y Fixing
7 Z Adjustment system
8 Chuck
9 Shaft
10 Nozzle system
11 Coating space
12 Outer leg
13 Inner leg
14 Inside ring surface
15 Vacuum system
16 Retaining system
17 Pins
18 Guide openings
19 Retaining surface
H Gap
t Height
d Thickness

1. Device for coating a surface of a wafer, said device comprising:
a retaining system for placing the wafer on a retaining surface and for rotating the wafer during coating;
a nozzle system for coating the wafer;
a ring having an inside periphery that surrounds a side periphery of the wafer said ring can be arranged for expanding a coating surface when coating the wafer; and
a Z-adjustment system for adjusting the ring in the Z-direction directed orthogonally to the retaining surface relative to the wafer.

2. Device according to claim 1, wherein the ring, is L-shaped in cross-section, said ring can be arranged concentrically to the wafer with a gap H between the inside periphery of the ring and the side periphery of the wafer of between 100 μm and 2,000 μm.

3. Device according to claim 1, wherein an upper ring surface of the ring can be arranged above the retaining surface in alignment with or above the surface of the wafer.

4. Device according to claim 1, wherein the ring can be adjusted by an X-Y adjustment system in an X-Y plane that runs parallel to the retaining surface relative to the wafer.

5. Device according to claim 1, wherein the Z-adjustment system is sliding-guided in the X-Y adjustment system in the Z-direction.

6. Device according to claim 1, wherein the ring can be arranged without contact on the wafer, said ring essentially equidistant in the Z-direction and/or orthogonal to the peripheral direction of the wafer.

7. Device according to claim 1, wherein the ring can be arranged in such a way that the coating surface is formed from the surface of the wafer and the upper ring surface of the ring that is directed in the Z-direction.

8. Device according to claim 2, wherein said gap H is between 100 μm and 500 μm.

9. Device for coating a surface of a wafer, said device comprising:
a retaining system for placing the wafer on a retaining surface;
a nozzle system for coating the wafer;
a ring for expanding a coating surface when coating the wafer,
wherein the ring includes an inside periphery that surrounds the wafer,
wherein the ring can be arranged on a side periphery of the wafer, and
wherein the ring can be adjusted by an Z adjustment system relative to the wafer in a Z-direction that runs orthogonally to the retaining surface; and
a X-Y-fixation means having a fixing ring for fixing the wafer in a X-Y-direction that runs parallel to the retaining surface.
